(19) United States
(12) Patent Application Publication
(10) Pub. No.: US 2009/0207189 A1
(43) Pub. Date: Aug. 20, 2009

(54) DISPLAY APPARATUS AND METHOD FOR PROCESSING IMAGE OBJECT

(76) Inventors: Lin-Yean Lin, Taichung County (TW); Hsi-Pin Li, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/194,510

(22) Filed: Aug. 19, 2008

(30) Foreign Application Priority Data
Feb. 16, 2008 (CN) 200810026364.1

(51) Int. Cl. G09G 5/373; G06F 3/041

(52) U.S. Cl. 345/660; 345/173

(57) ABSTRACT

A display apparatus includes a display unit and a touch panel. The display unit has a display panel. The touch panel is electrically connected to the display unit and corresponds to a selected region of the display panel, for processing an image object in the selected region. A method for processing an image object includes: enabling a touch panel; displaying an image on a display panel of a display unit, wherein a selected region of the display panel corresponds to the touch panel; and processing the image object in the selected region.

### BACKGROUND OF THE INVENTION

1. Field of the Invention

The present invention relates to a display apparatus and a method thereof for processing an image object, and more particularly, to a display apparatus and a method thereof particularly for processing an image object displayed on a large-size screen.

2. Description of the Prior Art

Due to the prevalence of electronic devices such as the digital still camera (DSC) and the digital video recorder (DV), capturing, storing and displaying still or dynamic images in a digital way has become a trend. As large-size digital display devices, such as the thin film transistor liquid crystal display (TFT-LCD), become more affordable, the large-size digital display device is increasing in popularity. A user can also enjoy a wide variety of entertainment while viewing photos or videos on the digital display device when the device has the capability to add characters or marks onto the viewed object.

Please refer to FIG. 1. FIG. 1 is a diagram of a television with a full screen touch panel illustrated in U.S. Pat. No. 7,215,815. The user is able to control the television according to the point the user touches on the touch panel. For a display apparatus with a full screen touch panel, the entire screen of the display apparatus is the touch panel. The cost of the touch panel gets more expensive since the size of the touch panel gets larger with the increasing size of the display apparatus screen. The term ‘visual angle’ means the angle between light rays from the two ends (e.g., left end and right end) of the viewed object as the light rays hit the center of the eyes of an observer. The degree of the visual angle is determined according to the size of the view object and the distance between the viewed object and the observer. Specifically, the degree of the visual angle gets greater as the distance between the observer and the object gets shorter, or the size of the object gets larger. For a display apparatus with a full screen touch panel, the farthest distance between the user and the touch panel while operating the display apparatus via the touch panel is approximately the length of an arm. Accordingly, when the screen size of the display apparatus gets larger, the degree of the visual angle between the user and the display apparatus gets greater. If the visual angle between the user and the display apparatus exceeds the viewing angle of the user, the field of human vision is insufficient to view the object in its entirety and this causes difficulty when operating the display apparatus. Therefore, there is a need to solve the abovementioned issues of display apparatus having a large-size screen.

### SUMMARY OF THE INVENTION

It is therefore one of the objectives of the present invention to provide a display apparatus and a method thereof particularly for processing an image object displayed on a large-size screen in order to solve the above-mentioned problem.

According to an exemplary embodiment of the present invention, a display apparatus is provided. The display apparatus comprises a display unit and a touch panel. The display unit has a display panel. The touch panel is electrically connected to the display unit and corresponds to a selected region of the display panel for processing an image object in the selected region.

According to an exemplary embodiment of the present invention, a method for processing an image object is also provided. The method comprises enabling a touch panel; displaying an image on a display panel of a display unit, wherein a selected region of the display panel corresponds to the touch panel; and processing the image object in the selected region.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional display panel with a full screen touch panel.

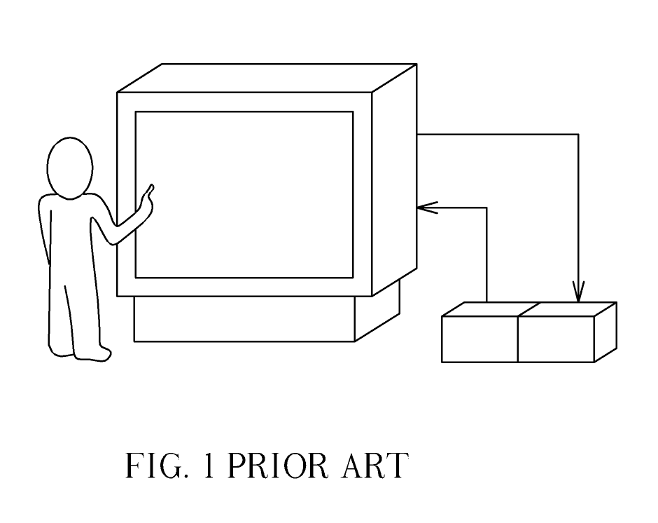

FIG. 2 is a schematic diagram illustrating an apparatus according to the present invention.

FIG. 3 is a flowchart illustrating a method of the present invention.

FIG. 4 is a diagram illustrating a first embodiment of the present invention.

FIG. 5 is a diagram illustrating a second embodiment of the present invention.

FIG. 6 is a diagram illustrating a third embodiment of the present invention.

### DETAILED DESCRIPTION

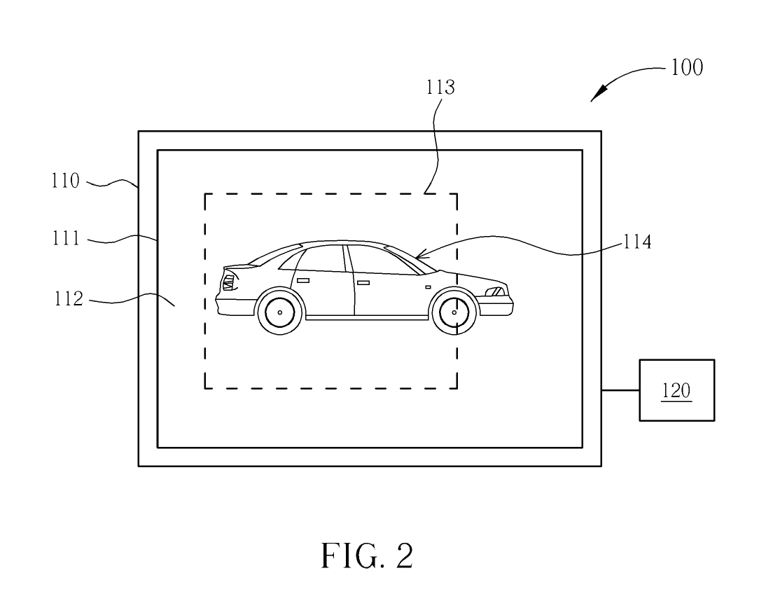

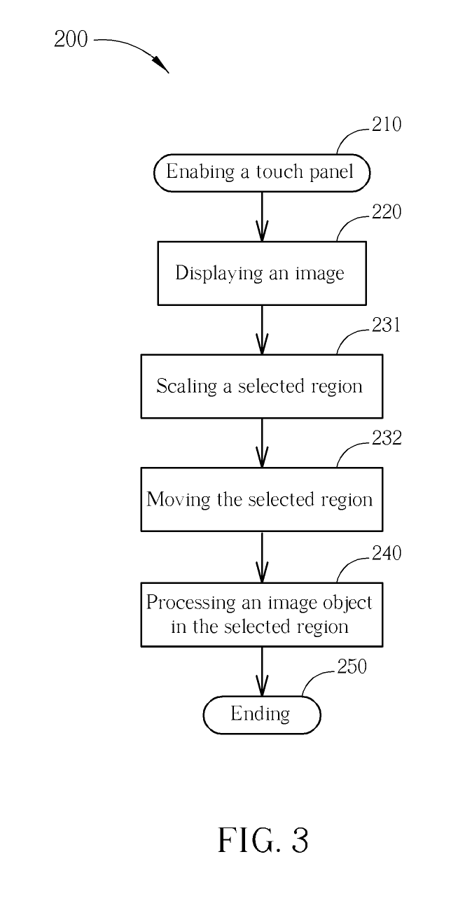

Please refer to FIG. 2 and FIG. 3. FIG. 2 is a schematic diagram illustrating an apparatus according to the present invention. FIG. 3 is a flowchart illustrating a method of the present invention. Further description is detailed as follows; however, this is only for illustrative purposes and not imitations of the present invention.

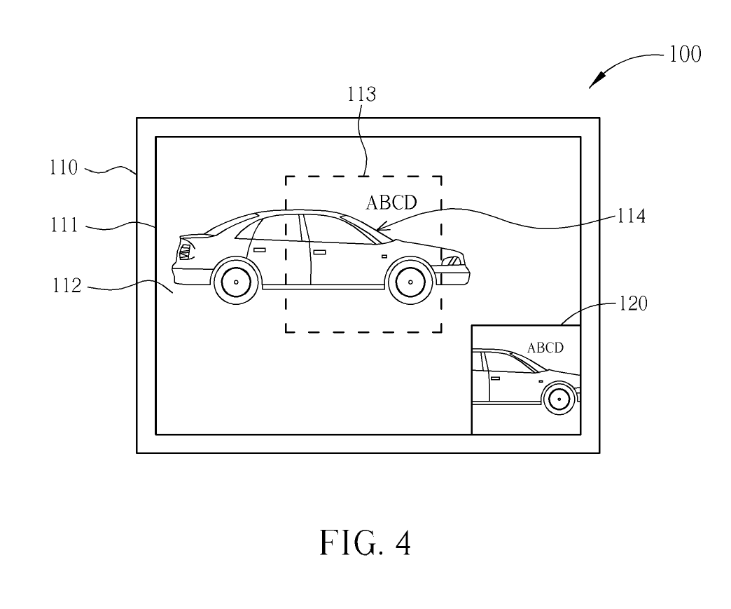

Please refer to FIG. 4. FIG. 4 is a diagram illustrating a display device 100 according to a first exemplary embodiment of the present invention. This embodiment is related to performing image processing on the display device 100.

As shown in FIG. 4, the display device 100 comprises a display unit 110 and a touch panel 120. The display unit 110 comprises a display panel 111 for displaying an image 112. The size of the touch panel 120 is designed to comply with a general writing size, such as A4 size. The touch panel 120 is electrically connected with and disposed on the display unit 110, and corresponds to a selected region 113 on the display panel 111. There is an image object 114 displayed inside the selected region 113.

For initializing the display device 100, the touch panel 120 is first enabled. The display panel 111 of the display unit 110 will display the image 112 and the touch panel 120 will display the image object 114 inside the selected region 113 simultaneously. The position and size of the selected region 113 may be adjusted by operating the display panel 120. The image object 114 inside the selected region 113 may be noted or modified via operating the touch panel 120; for example, noting the image object 114 by adding the characters “ABCD” on the image object 114, as shown in FIG. 4. Please note that the position and size of the selected region 113 may be readjusted depending on various requirements during the process of operating the display device 100.

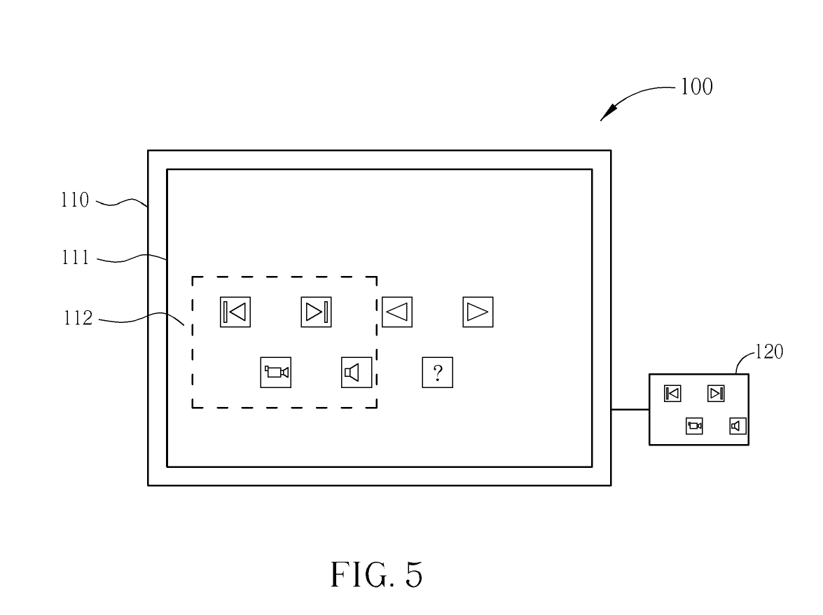

Please refer to FIG. 5. FIG. 5 is a diagram illustrating a display device 100 according to a second exemplary embodiment of the present invention. This embodiment is related to using a menu on the display device 100.

As shown in FIG. 5, the display device 100 comprises a display unit 110 and a touch panel 120. The display unit 110 comprises a display panel 111 for displaying an image 112. The size of the touch panel 120 is designed to comply with a general writing size, such as A4 size. The touch panel 120 is electrically connected with and attached to the display unit 110, and corresponds to a selected region 113 on the display panel 111. There is an image object 114 displayed inside the selected region 113.

For initializing the display device 100, the touch panel 120 is first enabled. The display panel 111 of the display unit 110 will display the image 112 that is a system menu, and the touch panel 120 will display the image object 114 inside the selected region 113 simultaneously. The position and size of the selected region 113 may be adjusted by operating the display panel 120. The image object 114 (i.e., the system menu) inside the selected region 113 may be selected or modified via operating the touch panel 120. Please note that the position and size of the selected region 113 may be readjusted depending on various requirements during the process of operating the display device 100.

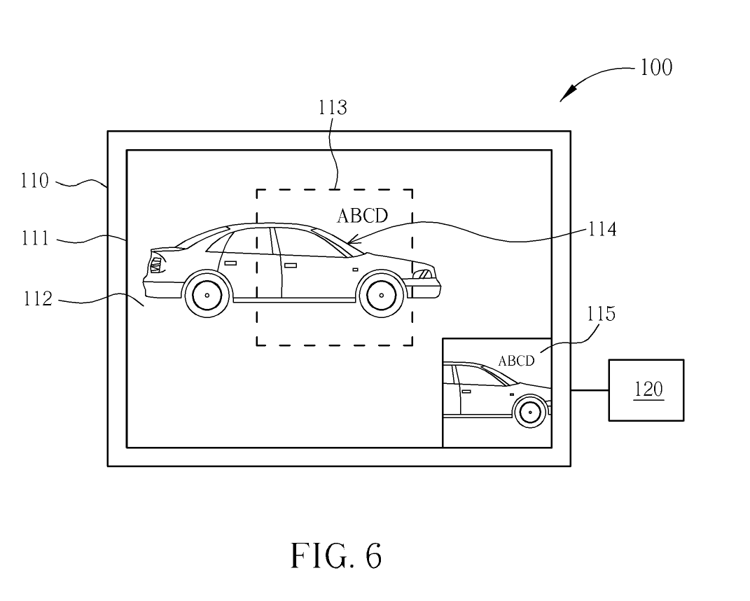

Please refer to FIG. 6. FIG. 6 is a diagram illustrating a display device 100 according to a third exemplary embodiment of the present invention. This embodiment is related to performing image processing on the display device 100.

As shown in FIG. 6, the display device 100 comprises a display unit 110 and a touch panel 120. The display unit 110 comprises a display panel 111 for displaying an image 112, and there is a sub picture 115 displayed in the image 112. The size of the touch panel 120 is designed to comply with a general writing size, such as A4 size. The touch panel 120 is electrically connected with and attached to the display unit 110, corresponding to a selected region 113 on the display panel 111. There is an image object 114 displayed inside the selected region 113, and the image object is also displayed in the sub-picture 115.

For initializing the display device 100, the touch panel 120 is first enabled. The display panel 111 of the display unit 110 will display the image 112, and the touch panel 120 will display the image object 114 inside the selected region 113 simultaneously. In addition, the image object 114 is displayed in the sub-picture 115. The position and size of the selected region 113 may be adjusted by operating the display panel 120. The image object 114 inside the selected region 113 may be noted or modified via operating the touch panel 120; for example, noting the image object 114 by adding the characters “ABCD” on the image object 114, as shown in FIG. 6. Please note that the position and size of the selected region 113 may be readjusted depending on various requirements during the process of operating the display device 100.

As mentioned in the description of the prior art, the large-size display device has a high cost as a result of the whole display screen being covered with the touch panel, and its visual angle is usually greater than the viewing angle of the user. Thus, the present invention focuses on the size of the observed object and the distance between the observer and the observed object, which determine the visual angle between the observer and the observed object, to solve the mentioned-above problems. With regard to the size of the observed object, the present invention designs a touch panel that is suitable for manual operation and easy to be handled. For example, the touch panel may be designed as A4 size, so that the user can watch the touch panel instead of the large-size screen to control the display device. On the other hand, with regard to the distance between the observer and the observed object, the touch panel can be disposed on the display device or attached to the display device depending on the design requirements. In addition, the touch panel corresponds to a selected region on the display panel, and the user is able to process an image object in the selected region.

Briefly summarized, the display device of the present invention has a user-friendly sized touch panel, which allows the user to control or input information easily by touching or writing thereon. In addition, the cost of the display device greatly decreases since the size of the touch panel is reduced. Therefore, the present invention can solve the problems of the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display apparatus, comprising:
a display unit, having a display panel; and
a touch panel, electrically connected to the display unit and corresponding to a selected region of the display panel, for processing an image object in the selected region.

2. The display apparatus of claim 1, wherein the touch panel is disposed on the display panel or is a portion of the display panel.

3. The display apparatus of claim 1, wherein the touch panel is attached to the display unit.

4. The display apparatus of claim 3, wherein the touch panel is a liquid crystal display touch panel.

5. The display apparatus of claim 3, wherein the touch panel is a writing pad.

6. The display apparatus of claim 1, being a television.

7. The display apparatus of claim 1, being a monitor.

8. The display apparatus of claim 1, having the capability to scale or move the selected region through the touch panel.

9. A method for processing an image object, comprising: enabling a touch panel;
displaying an image on a display panel of a display unit, wherein a selected region of the display panel corresponds to the touch panel; and
processing the image object in the selected region.

10. The method of claim 9, further comprising scaling or moving the selected region.
